(19) United States
(12) Patent Application Publication
(10) Pub. No.: US 2010/0190676 A1
(43) Pub. Date: Jul. 29, 2010

(54) COMPOSITION FOR ENHANCED REMOVAL OF BLOOD SOILS

(75) Inventors: Kim R. Smith, Woodbury, MN (US); Melissa C. Meinke, Minneapolis, MN (US); Robin M. Blank, Hopkins, MN (US); Yvonne M. Killeen, South St.Paul, MN (US); Victor F. Man, St. Paul, MN (US); Steven E. Lentsch, St. Paul, MN (US); Kristen A. Mills, Hopkins, MN (US)

Correspondence Address: ECOLAB USA INC., MAIL STOP ESC-F7, 655 LONE OAK DRIVE, EAGAN, MN, 55121, US

(73) Assignee: ECOLAB INC., St. Paul, MN (US)

(21) Appl. No.: 12/506,426

(22) Filed: Jul. 21, 2009

Related U.S. Application Data
(60) Provisional application No. 61/082,713, filed on Jul. 22, 2008.

(51) Int. Cl. C11D 3/386

(52) U.S. Cl. 510/161; 510/363; 510/281

(57) ABSTRACT

A composition for blood-containing soils is provided. The composition is useful in warewashing, hard surface cleaning, laundry, and in cleaning medical, dental, and animal care instruments and implements. A composition of the invention comprises an iron chelant, a reducing agent, and lysing agent. Compositions of the invention may be provided in concentrated form or as ready-to-use solutions and may be provided in liquid, powder, solid, or granulated forms. Optional additional ingredients include but are not limited to surfactants, pH modifiers, viscosity modifiers, water, builders, corrosion inhibitors, threshhold agents, anti-redeposition agents, aesthetic aids, antimicrobial agents, solidification agents, and processing aids. A desirable feature of the invention lies in its ability to clean blood-containing soils at low active concentrations. The invention further provides a method of removing blood-containing soils from a surface including applying a composition to a soil, the composition including an iron sequestrant, a reducing agent, and a lytic agent.

### RELATED APPLICATIONS

This application claims priority to U.S. Provisional Application Ser. No. 61/082,713 filed on Jul. 22, 2008 and entitled “Composition for Enhanced Removal of Blood Soils,” the entire disclosure of which is incorporated herein by reference.

### FIELD OF THE INVENTION

The following invention relates to removal of blood and/or protein soils. Compositions of the invention are useful in cleaning medical and dental instrumentation, fabric, hard surfaces, and the like. The invention further relates to methods of removing blood-containing soils.

### BACKGROUND OF THE INVENTION

Blood-containing soils are of significant economic importance to several industries including healthcare and meat processing plants in particular. Dried blood on instruments is hazardous to the employees of the hospital and to the next surgical patient upon which the instruments are used. The danger of handling instruments contaminated with blood is obvious in this age of hepatitis and HIV.

Cleaning dried blood is much more difficult than cleaning other soils. Blood-containing soils are particularly tenacious and difficult to remove for at least three reasons. First, red blood cell surfaces are hydrophobic and therefore difficult to wet with aqueous use solutions of detergents.

A second reason for the tenacity of blood-containing soils resides with hemoglobin that has limited water solubility and also contains iron. Iron is particularly difficult to remove from surfaces whether it is an automobile with iron-containing soil adhered to the surface, or a dental instrument with blood on the surface.

A third reason for difficulty in removal of blood-containing soils lies in the fact that blood-containing soils contain fibrin. Fibrin is a protein involved in the clotting of blood. It is a fibrillar protein that is polymerised to form a “mesh” that forms a hemostatic plug or clot (in conjunction with platelets) over a wound site. This “mesh” formation is a result of intermolecular cross-linking of cysteine in the protein. While it is desirable and necessary for clot formation, it also acts to make blood-containing stains all the more tenacious. The fibrin jams itself into microscopic irregularities in the surface of instrumentation and fabric. This is a physical attachment to the surface through mechanical means, not just chemical means as with traditional adhesives. The action is similar to the roots of plants growing into cracks in rocks, anchoring themselves to the surface.

The approach to removal of blood soils to date has primarily relied upon the use of high levels of caustic. However, there are drawbacks to using high amounts of caustic to clean delicate metal instrumentation. The foremost reason to avoid high amounts of caustic is that the cleaning composition may erode the metal thereby ruining the instruments instead of cleaning them. Another drawback is the exposure of the caustic to human skin. That is, the person engaged in the cleaning duty is exposed to the high alkalinity detergent that is at least irritating to human skin and eyes.

There is a need for a cleaning composition effective at removing blood and protein containing soils that is metal-safe.

### SUMMARY OF THE INVENTION

A novel detergent composition is disclosed that includes components to address each of the reasons for the tenacity of blood soils. The present composition allows for improved cleaning of cysteine-containing proteinaceous soils such as blood or egg. The composition comprises a lysing or hemolytic agent, an iron chelant, and a reducing agent.

In one embodiment the lysing agent is comprised of an enzyme such as a proteolytic enzyme and the composition comprises a near neutral pH. In another embodiment the lysing agent is comprised of an alkaline chemical such as an alkali metal hydroxide. The alkaline lysing agent may be comprised of sodium hydroxide.

In one embodiment the reducing agent is comprised of an alkali metal sulfite. An exemplary alkali metal sulfite includes but is not limited to sodium sulfite.

In one embodiment the iron chelant is comprised of an alkali metal gluconate such as sodium gluconate. The composition of the invention may further comprise a threshold agent, a surfactant, water, or a corrosion inhibitor. The invention composition is useful in cleaning blood and/or protein soils from medical instruments such as surgical instruments, scalpels, endoscopes, forceps, scissors, saws, or retractors.

At least one advantage of the invention lies in its effectiveness to clean at low active concentration. The composition may be provided as a solid or as a liquid and further may be provided in concentrated form suitable for dilution with water. Surprisingly, it was found that compositions of the invention are effective at cleaning blood and/or protein soils at an amount of about at least about 300 ppm actives.

A composition for cleaning medical components is disclosed comprising about 15 to 40 weight percent iron chelant, about 15 to 40 weight percent reducing agent, and about 15 to 40 weight percent lysing agent. In another embodiment a composition for cleaning medical components is disclosed comprising about 15 to 40 weight percent iron chelant, about 15 to 40 weight percent reducing agent, and about 0.1 to 10 weight percent lysing agent. In one embodiment the invention composition is substantially free of a caustic component.

### BRIEF DESCRIPTION OF THE FIGURES

FIG. 1 is a plot illustrating the performance of a cleaner prepared according to the invention (Formula C), comparative cleaners (A & B) and commercially available cleaners (Tec Wash III and Critiklenz®). A lower cumulative score is better with a score of zero being ideal. The plot illustrates that the invention (C) removes protein better than any of the other formulations, cleaned the Wash Check Strips better than formulations A & B and at least as well as the commercially available cleaners and also cleaned the TOSI plates very well.

FIG. 2 is a plot illustrating the cleaning performance of TOSI plates by a cleaner prepared according to the invention (Formula D) using a proteolytic enzyme as the lytic agent, and comparing it to Formula E (lacking the lytic agent) and two commercially available formulations. A higher score is better in this plot.

### DETAILED DESCRIPTION OF THE INVENTION

### Definitions

As used herein, the term “caustic-free” refers to a composition, mixture, or ingredient that does not contain a caustic or caustic-containing compound or to which a caustic or caustic-containing compound has not been added. Should a caustic or caustic-containing compound be present through contamination of a caustic-free composition, mixture, or ingredients, the amount of caustic shall be less than 0.5 wt %. More preferably, the amount of caustic is less then 0.1 wt-%, and most preferably, the amount of caustic is less than 0.01 wt %.

As used herein, the term “caustic-free” refers to a composition, mixture, or ingredient that does not contain caustic or a caustic-containing compound or to which caustic or a caustic-containing compound has not been added. Should caustic or a caustic-containing compound be present through contamination of a caustic-free composition, mixture, or ingredients, the amount of caustic shall be less than 0.5 wt %. More preferably, the amount of caustic is less than 0.1 wt-%, and most preferably the amount of caustic is less than 0.01 wt %. By use of the term “caustic,” it is meant any alkali metal hydroxide including but not limited to sodium hydroxide.

As used herein, the term “phosphate-free” refers to a composition, mixture, or ingredient that does not contain a phosphate or phosphate-containing compound or to which a phosphate or phosphate-containing compound has not been added. Should a phosphate or phosphate-containing compound be present through contamination of a phosphate-free composition, mixture, or ingredients, the amount of phosphate shall be less than 0.5 wt %. More preferably, the amount of phosphate is less then 0.1 wt-%, and most preferably, the amount of phosphate is less than 0.01 wt %.

As used herein, the term “phosphorus-free” refers to a composition, mixture, or ingredient that does not contain phosphorus or a phosphorus-containing compound or to which phosphorus or a phosphorus-containing compound has not been added. Should phosphorus or a phosphorus-containing compound be present through contamination of a phosphorus-free composition, mixture, or ingredients, the amount of phosphorus shall be less than 0.5 wt %. More preferably, the amount of phosphorus is less than 0.1 wt-%, and most preferably the amount of phosphorus is less than 0.01 wt %.

“Cleaning” means to perform or aid in soil removal, bleaching, microbial population reduction, rinsing, or combination thereof.

As used herein, the term “ware” includes items such as eating and cooking utensils. As used herein, the term “warewashing” refers to washing, cleaning, or rinsing ware.

As used herein, the term “hard surface” includes medical, dental or veterinary instruments, showers, sinks, toilets, bathtubs, countertops, windows, mirrors, transportation vehicles, floors, and the like. These surfaces can be those typified as “hard surfaces” (such as walls, floors, bed-pans, etc.,), or fabric surfaces, e.g., knit, woven, and non-woven surfaces (such as surgical garments, draperies, bed linens, bandages, etc.,), or patient-care equipment (such as respirators, diagnostic equipment, shunts, body scopes, wheel chairs, beds, etc.,), or surgical and diagnostic equipment.

As used herein, the phrase “health care surface” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in hospital, surgical, infirmity, birthing, mortuary, and clinical diagnosis rooms. Health care surfaces include articles and surfaces employed in animal health care.

As used herein, the term “instrument” refers to the various medical or dental instruments or devices that can benefit from cleaning with a stabilized composition according to the present invention.

As used herein, the phrases “medical instrument”, “dental instrument”, “medical device”, “dental device”, “medical equipment”, or “dental equipment” are used interchangeably herein and refer to instruments, devices, tools, appliances, apparatus, and equipment used in medicine or dentistry. Such instruments, devices, and equipment can be cold sterilized, soaked or washed and then heat sterilized, or otherwise benefit from cleaning in a composition of the present invention. These various instruments, devices and equipment include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, scopes (e.g., endoscopes, stethoscopes, and arthoscopes) and related equipment, and the like, or combinations thereof

As used herein, a solid cleaning composition refers to a cleaning composition in the form of a solid such as a powder, a particle, an agglomerate, a flake, a granule, a pellet, a tablet, a lozenge, a puck, a briquette, a brick, a solid block, a unit dose, or another solid form known to those of skill in the art. The term “solid” refers to the state of the detergent composition under the expected conditions of storage and use of the solid detergent composition. In general, it is expected that the detergent composition will remain in solid form when exposed to temperatures of up to about 100° F. and greater than about 120° F.

By the term “solid” as used to describe the processed composition, it is meant that the hardened composition will not flow perceptibly and will substantially retain its shape under moderate stress or pressure or mere gravity, as for example, the shape of a mold when removed from the mold, the shape of an article as formed upon extrusion from an extruder, and the like. The degree of hardness of the solid cast composition can range from that of a fused solid block, which is relatively dense and hard, for example, like concrete, to a consistency characterized as being malleable and sponge-like, similar to caulking material.

As used herein, weight percent (wt-%), percent by weight, % by weight, and the like are synonyms that refer to the concentration of a substance as the weight of that substance divided by the total weight of the composition and multiplied by 100.

The term “about,” as used herein, modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about,” the claims include equivalents to the quantities. All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

The recitation of numerical ranges by endpoints includes all numbers subsumed within that range (e.g. 1 to 5 includes 1, 1.5, 2, 2.75, 3, 3.80, 4, and 5).

The present invention contemplates the possibility of omitting any components listed herein. The present invention further contemplates the omission of any components even though they are not expressly named as included or excluded from the invention.

The present invention is useful in preparing and in use as a presoak or prewash, or a cleaning agent for treating a variety of surfaces. Compositions prepared according to the invention are useful in cleaning blood and/or protein containing soils. Compositions prepared according to the present invention are useful in automatic warewashing machines, in hand dishwashing to a certain extent, in cleaning hard surfaces such as windows, mirrors, ceramic tile and basins, granite, plastic, stainless steel, wood, countertops, or vehicles to name a few to the extent that they contain blood-containing proteinaceous soils or other proteinaceous soils with a high cysteine content such as eggs which contain about 0.27% cysteine. The level of cysteine residues in various other proteins is readily available in numerous references known to those in the art. Compositions prepared according to the invention are particularly useful in cleaning or treating medical or dental equipment or instruments and in washing linens, in cleaning healthcare surfaces and the like all to the extent that they contain blood-containing and/or protein-containing soils.

### Hemolytic Agent

The composition of the invention includes a hemolytic agent otherwise known as a blood lysing agent. The hemolytic agent is included to lyse the red blood cells contained in the blood soil thereby exposing them to further attack by detergent. The hemolytic agent may be a source of alkalinity.

Soil removal is most commonly obtained from a source of alkalinity used in manufacturing a cleaning composition. Sources of alkalinity can be organic, inorganic, and mixtures thereof. Organic sources of alkalinity are often strong nitrogen bases including, for example, ammonia (ammonium hydroxide), amines, alkanolamines, and amino alcohols. Typical examples of amines include primary, secondary or tertiary amines and diamines carrying at least one nitrogen linked hydrocarbon group, which represents a saturated or unsaturated linear or branched alkyl group having at least 10 carbon atoms and preferably 16-24 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups. Typical examples of alkanolamines include monoethanolamine, monopropanolamine, diethanolamine, dipropanolamine, triethanolamine, tripropanolamine and the like. Typical examples of amino alcohols include 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like.

Exemplary sources of inorganic alkalinity also include alkali metal hydroxides, alkali metal carbonates, sesquicarbonates, and bicarbonates, and mixtures thereof. Typical examples of alkali metal hydroxides include sodium hydroxide, potassium hydroxide, and lithium hydroxide. Exemplary alkali metal salts include sodium carbonate, potassium carbonate, and mixtures thereof. It is understood that the use of alkali metal hydroxides may be detrimental to the surface intended to be cleaned such as, for example, metal surfaces. When intending to clean delicate metal surfaces prone to corrosion such as medical instruments, compositions of the invention should be substantially free of or free of caustic components.

The hemolytic agent may be a source of alkalinity such as an organic solvent with lytic activity such as glycol ethers, benzyl alcohol, or the like. Yet another hemolytic agent useful in the present composition may comprise a source of high ionic strength such as sodium chloride.

Another source of hemolytic agent useful in the present invention are enzymes. Enzymes such as proteolytic enzymes are useful in compositions of the invention. Since enzymes are proteins, it is important that the other components of the composition not serve to denature the lytic enzyme thus rendering it ineffective for its intended purpose. Examples of suitable enzymes include but are not limited to proteolytic enzymes such as Esperase™, Alcalase™, and Savinase™ available from Novozymes. For compositions of the invention incorporating active enzymes or enzymes otherwise stabilized (such as is the case with bacterial spores capable of producing active enzymes), the pH of the composition becomes important. That is, the pH of a composition of the invention including an enzymatic ingredient should be such that the enzymatic component remains stable and is not denatured. Such a pH may be at or near about neutral pH or between about 6 and 8.

Another consideration when incorporating an enzymatic ingredient into compositions of the invention is the amount of water present. As with pH, water can serve to denature enzymes or germinate a component that may be present as a spore. For compositions including enzymatic components, the amount of water may need to be limited to ensure enzymatic activity remains stable over the shelf life of the composition.

In a composition of the invention, the hemolytic agent is present in an amount from about 0.1 to about 90 weight percent, from about 1 to about 50 weight percent, and from about 2 to about 40 weight percent. If the hemolytic agent is supplied in the form of a source of alkalinity, the amount of hemolytic agent incorporated into the composition is higher than if it is an enzyme. For instance, if the hemolytic agent is comprised of an enzyme, it is present in an amount from about 0.1 to about 10 weight percent, from about 0.2 to about 9 weight percent, and from about 1 to about 8 weight percent. If the hemolytic agent is supplied in the form of a source of alkalinity, it is present in an amount from about 0.1 to about 90 weight percent, from about 1 to about 50 weight percent, and from about 15 to about 40 weight percent.

### Chelant/Sequestrant

Another component of the invention composition is a chelant/sequestrant effective to remove iron from the hemoglobin of the lysed red blood cells. As used herein, the terms “chelating agent” and “sequestrant” refer to a compound that forms a complex (soluble or not) with iron ions. As used herein, the terms “chelating agent” and “sequestrant” are synonymous. The iron chelant should have a stability constant for iron greater than that of citric acid but the exact value of that constant will vary with pH. Both organic and inorganic chelating agents can be used. Organic chelating agents include both polymeric and small molecule chelating agents. Organic small molecule chelating agents are typically organocarboxylate compounds or organophosphate chelating agents. These include but are not limited to hydroxycarboxylates, aminocarboxylates, amino acids such as cysteine and histamine to name a couple, salicylic acid and its derivatives, and fumaric acid and fulvic acid. Polymeric chelating agents commonly comprise polyanionic compositions such as polyacrylic acid compounds. Polymers such as Acusol 448 available from Rohm & Haas and others are also useful in the present invention. Small molecule organic chelating agents include sodium gluconate, sodium glucoheptonate, N-hydroxyethylenediaminetriacetic acid (HEDTA), ethylenediaminetetraacetic acid (EDTA), nitrilotriaacetic acid (NTA), diethylenetriaminepentaacetic acid (DTPA), ethylenediaminetetraproprionic acid, triethylenetetraaminehexaacetic acid (TTHA), and the respective alkali metal, ammonium and substituted ammonium salts thereof, ethylenediaminetetraacetic acid tetrasodium salt (EDTA), nitrilotriacetic acid and its salts such as nitrilotriacetic acid trisodium salt (NTA), ethanoldiglycine disodium salt (EDG), diethanolglycine sodium-salt (DEG), and 1,3-propylenediaminetetraacetic acid (PDTA), dicarboxymethyl glutamic acid tetrasodium salt (GLDA), methylglycine-N—N-diacetic acid trisodium salt (MGDA), and iminodisuccinate sodium salt (IDS). All of these are known and commercially available. Small molecule organic chelating agents also include biodegradable sequestrants having chelating functionalities from EDG, MGDA and GLDA-type molecules. Other sequestrants include ethanoldiglycine disodium salt (EDG), dicarboxymethyl glutamic acid tetrasodium salt (GLDA), and methylglycine-N—N-diacetic acid trisodium salt (MGDA).

In a composition of the invention, the iron chelant is present in an amount from about 0.1 to about 90 weight percent, from about 1 to about 50 weight percent, and from about 15 to about 40 weight percent.

### Reducing Agent

Another component of the invention composition includes a reducing agent. In at least one embodiment, the reducing agent should be capable of converting a disulfide bond to a thiol group. Without being bound by theory, it is believed that blood-containing soils are at least in part tenacious due to the existence of disulfide bridging or crosslinking of sulfur in fibrin. The sulfur in the fibrin crosslinks with itself, making the soil difficult to remove. A reducing agent can eliminate or reduce these crosslinks by converting the disulfide bonds to thiol groups. Since the composition of the invention is likely diluted with water, in a preferred embodiment the reducing agent is nonreactive with water. Nonlimiting examples of reducing agents include sulfite, metasulfite, bisulfite, and metabisulfate to name a few. Exemplary reducing agents include alkali metal sulfites including but not limited to sodium sulfite.

In a composition of the invention, the reducing agent is present in an amount from about 0.1 to about 90 weight percent, from about 1 to about 50 weight percent, and from about 15 to about 40 weight percent.

### Optional Ingredients

The cleaning composition of the invention comprises an iron chelant, reducing agent, and lysing agent. However, it may contain other optional components. Such optional additional ingredients include but are not limited to surfactants including nonionic, anionic, cationic and amphoteric surfactants. The term “surfactant” or “surface active agent” refers to an organic chemical that when added to a liquid changes the properties of that liquid at a surface.

Another additional optional ingredient may include a pH modifier as may be supplied by certain acids and bases. Yet other additional optional ingredients include but are not limited to viscosity modifiers, water, builders, corrosion inhibitors, threshhold agents, anti-redeposition agents, aesthetic aids, antimicrobial agents, solidification agents, and processing aids. The term “threshold agent” refers to a compound that inhibits crystallization of water hardness ions from solution, but that need not form a specific complex with the water hardness ion. Threshold agents include but are not limited to a polyacrylate, a polymethacrylate, an olefin/maleic copolymer, and the like. An “antiredeposition agent” refers to a compound that helps keep suspended in water instead of redepositing onto the object being cleaned. Antiredeposition agents are useful in the present invention to assist in reducing redepositing of the removed soil onto the surface being cleaned.

Corrosion inhibitors that may be optionally added to the composition of the invention include silicates, phosphate, magnesium and/or zinc ions. Exemplary silicates include sodium metasilicates, sesquisilicates, orthosilicates, potassium silicates, and mixtures thereof.

Aesthetic enhancing agents such as colorants and perfume are also optionally incorporated into the concentrate composition of the invention. Examples of colorants useful in the present invention include but are not limited to liquid and powdered dyes from Milliken Chemical, Keystone, Clariant, Spectracolors, Pylam, and Liquitint Violet 0947 commercially available from Milliken Chemical.

Examples of perfumes or fragrances useful in concentrate compositions of the invention include but are not limited to liquid fragrances from J&E Sozio, Firmenich, and IFF (International Flavors and Fragrances).

Preservatives are optional and are generally preferred when the concentrate and use solution pH is not high enough to mitigate bacterial growth in the concentrate. Examples of preservatives useful in compositions of the invention include but are not limited to methyl paraben, glutaraldehyde, formaldehyde, 2-bromo-2-nitropropane-1,3-diol, 5-chloro-2-methyl-4-isothiazoline-3-one, and 2-methyl-4-isothiazoline-3-one. Preservatives can be included up to about 2 wt %, up to about 1 wt %, and up to about 0.5 wt %.

It should be understood that the optional water provided as part of the concentrate can be relatively free of hardness. It is expected that the water can be deionized to remove a portion of the dissolved solids. The concentrate is then diluted with water available at the locale or site of dilution and that water may contain varying levels of hardness depending upon the locale. Although deionized is preferred for formulating the concentrate, the concentrate can be formulated with water that has not been deionized. That is, the concentrate can be formulated with water that includes dissolved solids, and can be formulated with water that can be characterized as hard water.

Service water available from various municipalities has varying levels of hardness. It is generally understood that the calcium, magnesium, iron, manganese, or other polyvalent metal cations that may be present can cause precipitation of the anionic surfactant. In general, because of the expected large level of dilution of the concentrate to provide a use solution, it is expected that service water from certain municipalities will have a greater impact on the potential for anionic surfactant precipitation than the water from other municipalities. As a result, it is desirable to provide a concentrate that can handle the hardness levels found in the service water of various municipalities. The water of dilution that can be used to dilute the concentrate can be characterized as hard water when it includes at least 1 grain hardness. It is expected that the water of dilution can include at least 5 grains hardness, at least 10 grains hardness, or at least 20 grains hardness.

It is expected that the concentrate will be diluted with the water of dilution in order to provide a use solution having a desired level of detersive properties. Alternatively, the composition of the invention is provided as a use solution.

### Delivery Modes

The concentrate composition of the invention can be provided as a solid, liquid, or gel. In one embodiment of the invention, the composition concentrate is provided as a capsule or pellet of compressed powder, a solid, or loose powder, either contained by a water soluble material or not. In the case of providing the capsule or pellet of the composition in a material, the capsule or pellet can be introduced into a volume of water, and if present the water soluble material can solubilize, degrade, or disperse to allow contact of the composition concentrate with the water. For the purposes of this disclosure, the terms “capsule” and “pellet” are used for exemplary purposes and are not intended to limit the delivery mode of the invention to a particular shape.

In another embodiment, the liquid concentrate composition (other than those suitable for substrate coating) can be diluted through dispensing equipment using aspirators, peristaltic pumps, gear pumps, mass flow meters, and the like. This liquid concentrate embodiment can also be delivered in bottles, jars, dosing bottles, bottles with dosing caps, and the like. The liquid concentrate composition (other than those suitable for substrate coating) can be filled into a multi-chambered cartridge insert that is then placed in a spray bottle or other delivery device filled with a pre-measured amount of water. The liquid concentrate composition (other than those suitable for substrate coating) can also be diluted at the manufacturing site and packaged as a ready-to-use (RTU) use solution.

In yet another embodiment, the concentrate composition can be provided in a solid form that resists crumbling or other degradation until placed into a container. Such container may either be filled with water before placing the composition concentrate into the container, or it may be filled with water after the composition concentrate is placed into the container. In either case, the solid concentrate composition dissolves, solubilizes, or otherwise disintegrates upon contact with water. In a preferred embodiment, the solid concentrate composition dissolves rapidly thereby allowing the concentrate composition to become a use composition and further allowing the end user to apply the use composition to a surface in need of cleaning

In another embodiment, the solid concentrate composition can be diluted through dispensing equipment whereby water is sprayed at the solid block forming the use solution. The water flow is delivered at a relatively constant rate using mechanical, electrical, or hydraulic controls and the like. The solid concentrate composition can also be diluted through dispensing equipment whereby water flows around the solid block, creating a use solution as the solid concentrate dissolves. The solid concentrate composition can also be diluted through pellet, tablet, powder and paste dispensers, and the like.

### Compositions of the Invention

A couple of useful ranges for the basic composition for a cleaning concentrate prepared according to the present invention include those provided in the following table:

| | Weight | Weight | Weight |
|---|---|---|---|
| Component | percent | percent | percent |
| Iron Chelant | 0.1-90 | 1-50 | 15-40 |
| Reducing Agent | 0.1-90 | 1-50 | 15-40 |
| Lysing Agent | 0.1-90 | 1-50 | 15-40 |

In an alternate embodiment, a cleaning concentrate prepared according to the present invention include those provided in the following table:

| | Weight | Weight | Weight |
|---|---|---|---|
| Component | percent | percent | percent |
| Iron Chelant | 0.1-90 | 1-50 | 15-40 |
| Reducing Agent | 0.1-90 | 1-50 | 15-40 |
| Enzymatic Lysing Agent | 0.1-10 | 0.2-8 | 0.5-6 |

Exemplary compositions of the invention using enzymes as the lytic agent may be prepared according to the formulations contained in the table below:

| Formula Components | Percentage by weight | |
|---|---|---|
| Sodium Gluconate | 15.1 | 59.7 |
| Sodium | 10.4 | 10.4 |
| Sesquicarbonate | | |
| Sodium Sulfite | 59.7 | 15.1 |
| Acusol 445 ND | 4.8 | 4.8 |
| Esperase MG | 5 | 5 |
| Water | 5 | 5 |
| Lipase | .001 | .001 |
| Amylase | .001 | .001 |
| Cellulase | .001 | .001 |

The table below provides ranges for the various optional ingredients that may be added to the compositions provided in the tables above:

| | Weight | Weight | Weight |
|---|---|---|---|
| Component | percent | percent | percent |
| Surfactant | 0-20 | 0-9 | 0-4 |
| Viscosity Modifier | 0-10 | 0-4 | 0-2 |
| Water | 0-90 | 0-49 | 0-24 |
| Builder (apart | 0-40 | 0-19 | 0-9 |
| from iron chelant) | | | |
| Corrosion | 0-10 | 0-8 | 0-4 |
| Inhibitor | | | |
| Threshold Agent | 0-10 | 0-8 | 0-4 |
| Anti-redeposition | 0-10 | 0-8 | 0-4 |
| Agent | | | |
| Aesthetic Aids | 0-10 | 0-8 | 0-4 |
| Antimicrobial | 0-10 | 0-8 | 0-4 |
| Agent | | | |
| Solidification | 0-80 | 0-39 | 0-19 |
| Agent | | | |
| Processing Aid | 0-80 | 0-39 | 0-19 |

A particular advantage of the composition of the invention lies not only in its remarkable ability to remove blood-containing soils but also lies in its effectiveness at low actives concentration. Compositions of the invention are effective at actives concentration as low as about 300 ppm, about 350 ppm, about 400 ppm, and about 450 ppm.

The invention further provides a method of removing blood-containing soil from a surface. The method is useful for removing blood-containing soils from any surface. Such surfaces include, but are not limited to textiles, hard surfaces including flooring and medical instruments. The method includes contacting a blood-containing soil with a composition comprising a hemolytic agent, a reducing agent, and an iron-sequestrant. The contact time of the soil with the composition may vary from a fraction of a minute up to hours depending upon the severity of the soil. Once contact with the composition and the soil has occurred, the surface may be wiped with a clean rag or utensil or rinsed with water or some other liquid compatible with the soil-containing surface. Methods of the invention employ compositions having from about 15-40 wt % lysing agent, about 15-40 wt % reducing agent, and about 15-40 wt % lysing agent. As previously discussed, the lysing agent may in part or in total be provided as an enzyme and when the lysing agent is an enzyme it is present in the composition useful in the method of the invention in an amount from about 0.1 to 10 wt %. The present invention can be better understood with reference to the following examples. These examples are intended to be representative of specific embodiments of the invention, and are not intended as limiting the scope of the invention.

### Examples

### Example 1

### Effect of Reducing Agent

TOSI plates (Test Object Surgical Instruments) are commercially available test substrates that are comprised of stainless steel coupons soiled with dried blood and a fibrin source. The stainless steel plate is “scratched” or “grooved,” replicating the uneven surface of surgical instruments. The TOSI is made in a quality-controlled environment (ISO certified facility), ensuring consistency among individual tests. The benefit of a reducing agent to convert fibrin to a more water soluble form was measured. Test solutions as shown below were heated to 150° F. and TOSI plates were placed in the solutions for 5 minutes for soil removal. The treated plates were then rinsed with cold water, air-dried, and observed for visual evaluation of the surface area still covered by soil. The results show a clear benefit when using a reducing agent in the removal of fibrin.

| Sample | [NaOH] | [Na sulfite] | Cleaning Result |
|---|---|---|---|
| 1-A | 100 ppm | 0 | ~50% soil removed |
| 1-B | 100 ppm | 100 ppm | total soil removal |

### Example 2

### Effect of Iron Chelant

TOSI plates were tested as in Example 1 using the below compositions to evaluate the benefit of improved iron chelation. While both citrate and gluconate are known iron chelants, the data below shows that gluconate is the more powerful of the two in iron sequestration.

| Sample | [NaOH] | [Fe Chelant] | Cleaning Result |
|---|---|---|---|
| 2-C | 100 ppm | 400 ppm Na | ~50% soil removed; |
| | | citrate | remaining soil was |
| | | | red (blood & fibrin) |
| 2-D | 100 ppm | 400 ppm Na | ~75% soil removed; |
| | | gluconate | remaining soil is tan |
| | | | (mostly fibrin) |

### Example 3

### Washer Test

A solid detergent composition of the invention (Formula C) was prepared by compressing the mixed raw materials. Comparative Formulae A and B were also prepared by compressing mixed raw materials. Formulae A, B, and C had the following compositions:

| | | Comparative | Comparative |
|---|---|---|---|
| | Formula C | Formula A | Formula B |
| Component | (wt %) | (wt %) | (wt %) |
| Sodium hydroxide | 25% | 25% | 25% |
| Sodium sulfite | 20% | — | — |
| Sodium gluconate | 50% | 50% | 50% |
| (m.w. ~4500) | | | |
| Sodium polyacrylate | 5% | 5% | 5% |
| N Sodium silicate* | — | — | 20% |
| BW Sodium silicate** | — | 20% | |
| Aluminum safe? | Yes | Yes | Yes |

*3.2SiO₂/Na₂O from Philadelphia Quartz
**2.4SiO₂/Na₂O from Philadelphia Quartz

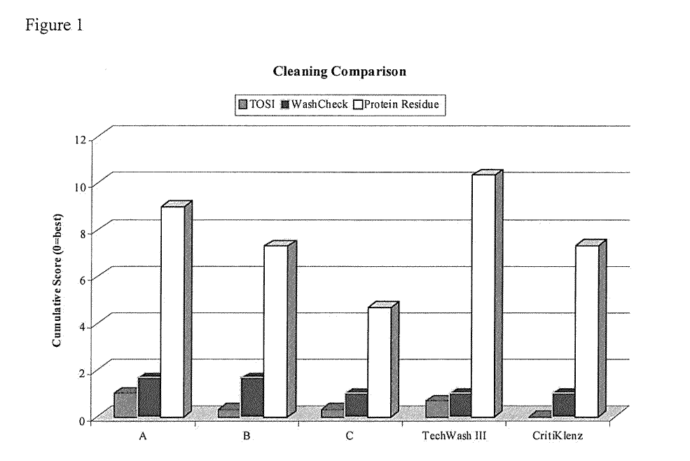

These formulae were then dispensed at 400 ppm into an instrument cleaner/disinfector washing machine and compared to commercially available detergents, Tec Wash III from Getinge AB and CritiKlenz® from STERIS Corporation, at their label recommended use concentrations. FIG. 1 shows the combined score for cleaning three types of soil: TOSI plates (as described in Example 1), Wash Check strips (from HealthMart), and a measure of total protein residue as detected by o-phthalaldehyde and a uv absorbance instrument. The scores for three replicates of each test type were combined. A lower cumulative score is better with a score of zero being ideal. The plot illustrates that the invention (Formula C) removes protein better than any of the other formulations, cleaned the Wash Check Strips better than Comparative Formulations A & B and at least as well as the commercially available cleaners and also cleaned the TOSI plates very well.

### Example 4

### Formulations Containing Enzymatic Lytic Agent

Two formulations were prepared to demonstrate the effect of the proteolytic enzyme. Formulae D (prepared according to the invention) and E (comparative) had the compositions shown in the table below.

| | | Percentage by weight | |
|---|---|---|---|
| | | Formula | Formula |
| Raw Material | Purpose | D | E |
| Sodium Gluconate | Chelant/Sequesterant | 50 | 50 |
| Sodium Sulfite | Reducing Agent | 30 | 30 |
| Sodium Sesquicarbonate | pH Buffer | 15 | 15 |
| Protease | Hemolytic Agent | 5 | 0 |
| Water | Filler | 0 | 5 |

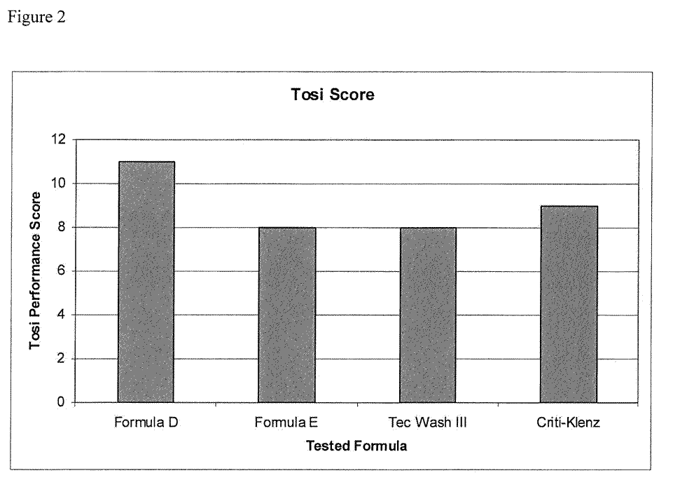

The cleaning capacity of Formulae D and E, along with two commercially available cleaners, Tec Wash III and Criti-Klenz sold as premixed 10,000 ppm solutions, were tested using TOSI plates. One TOSI plate was soaked for 30 minutes in each of the solutions. FIG. 2 illustrates the results. The results for this example were graded according to a visual scale summarized in the table below:

| Rating | Soil Description Remaining on TOSI |
|---|---|
| 0 | No removal |
| 1 | Removal of some red color, no |
| | removal of brown color |
| 2 | Removal of 0-33% of brown soil |
| 3 | Removal of 33-67% of brown soil |
| 4 | Removal of 67-100% of brown soil |
| 5 | Removal of 0-33% of clear soil |
| 6 | Removal of 33-67% of clear soil |
| 7 | Removal of 67-100% of clear soil |
| 8 | No thicker soil remaining, 67-100% |
| | of shadow remaining |
| 9 | 33-67% of shadow remaining |
| 10 | 1-33% of shadow remaining |
| 11 | Soil completely removed |

FIG. 2 illustrates the superior cleaning ability of Formula D as compared to Formula E (comparative formula) and the commercially available formulae.

The invention has been described with reference to various specific and preferred embodiments and techniques. However, it should be understood that many variations and modifications may be made while remaining within the spirit and scope of the invention.

We claim:

1. A composition for cleaning medical instruments, comprising:
an iron chelant comprised of an alkali metal gluconate;
a reducing agent comprised of an alkali metal sulfite; and
a lysing agent comprised of an enzyme or an alkaline chemical.

2. The composition of claim 1 wherein the enzyme is comprised of a protease.

3. The composition of claim 1 wherein the composition comprises an about neutral pH

4. The composition of claim 1 wherein the alkaline chemical is comprised of an alkali metal hydroxide, alkali metal carbonate, alkali metal sesquicarbonate, alkali metal bicarbonate, or mixtures thereof.

5. The composition of claim 1 wherein the alkali metal is comprised of sodium, potassium, lithium, or mixtures thereof.

6. The composition of claim 1 further comprising a threshold agent, a surfactant, water, or a corrosion inhibitor.

7. The composition of claim 1 wherein the medical instruments are comprised of surgical instruments, scalpels, endoscopes, forceps, scissors, saws, or retractors.

8. The composition of claim 1 wherein the composition comprises a concentrate suitable for dilution with water.

9. The composition of claim 1 wherein an effective amount of cleaner is comprised of about at least about 300 ppm actives.

10. The composition of claim 1 wherein the composition is substantially free of caustic.

11. A composition for cleaning blood and protein soils, comprising about 15 to 40 weight percent iron chelant comprised of an alkali metal gluconate; about 15 to 40 weight percent reducing agent comprised of an alkali metal sulfite, and about 1 to 40 weight percent lysing agent comprised of an enzyme or an alkaline chemical or a combination thereof.

12. The composition of claim 11 wherein the iron chelant is comprised of sodium gluconate and the reducing agent is comprised of sodium sulfite.

13. The composition of claim 11 wherein the composition comprises a laundry detergent or a hard surface cleaner.

14. The composition of claim 11 further comprising a threshold agent, a surfactant, water, or a corrosion inhibitor.

15. The composition of claim 11 wherein the composition comprises a concentrate suitable for dilution with water.

16. The composition of claim 11 wherein an effective amount of cleaner is comprised of about at least about 350 ppm actives.

17. A composition for cleaning medical components, comprising about 15 to 40 weight percent iron chelant comprised of sodium gluconate; about 15 to 40 weight percent reducing agent comprised of sodium sulfite; and about 1 to 8 weight percent lysing agent comprised of an enzyme.

18. The composition of claim 17 wherein the composition comprises a concentrate suitable for dilution with water.

19. The composition of claim 17 wherein an effective amount of cleaner is comprised of about at least about 300 ppm actives.

20. The composition of claim 1 wherein the composition is substantially caustic free or caustic free.

21. A composition for cleaning medical components, comprising sodium hydroxide, sodium sulfite, and sodium gluconate.

22. A method of removing blood-containing soils from a surface, comprising the steps of:
contacting a blood-containing soil with a composition, the composition comprising about 15 to 40 weight percent iron chelant comprised of sodium gluconate; about 15 to 40 weight percent reducing agent comprised of sodium sulfite; and about 1 to 8 weight percent lysing agent comprised of an enzyme;
and removing the composition from the surface.

23. The method of claim 22 wherein the surface comprises a medical instrument, or a textile.

24. A method of removing blood-containing soils from a surface, comprising the steps of:
contacting a blood-containing soil with a composition, the composition comprising about 15 to 40 weight percent iron chelant comprised of an alkali metal gluconate; about 15 to 40 weight percent reducing agent comprised of an alkali metal sulfite, and about 1 to 40 weight percent lysing agent comprised of an enzyme or an alkaline chemical or a combination thereof; and
removing the composition from the surface.

25. The method of claim 24 wherein the surface comprises a medical instrument, or a textile.
